(19) United States
(12) Patent Application Publication
(10) Pub. No.: US 2016/0137144 A1
(43) Pub. Date: May 19, 2016

(54) LIGHTWEIGHT FLOATING LICENSE PLATE BRACKET

(71) Applicant: FORD GLOBAL TECHNOLOGIES, LLC, Dearborn, MI (US)

(72) Inventor: Francisco Javier Quintero Perez, Uruapan (MX)

(21) Appl. No.: 14/543,051

(22) Filed: Nov. 17, 2014

(51) Int. Cl. B60R 13/10; B60K 13/06; G09F 7/18

(52) U.S. Cl. CPC B60R 13/105; G09F 7/18; B60K 13/06

(57) ABSTRACT

A motor vehicle fascia assembly includes a fascia panel and a floating license plate bracket providing a lower profile, improved air flow to a vehicle engine, and reduced interference with sensors associated with the fascia assembly.

### TECHNICAL FIELD

This disclosure relates generally to motor vehicle fascia, and more particularly to a vehicle fascia assembly including a license plate bracket providing a lower profile, improved air flow to a vehicle engine, and reduced interference with sensors associated with the fascia assembly.

### BACKGROUND

Modern motor vehicles are equipped with fascia which among other functions provide a covering for bumper assemblies, and further which contribute to the aerodynamic properties and aesthetic appearance of the motor vehicle so equipped. As one element of a motor vehicle fascia, there is may be provided a portion to which a license plate bracket can be attached, providing a place to secure a license plate proving vehicle identification information as is required under most if not all national laws.

Conventional license plate brackets include a substantially flat front surface to which the license plate is attached, but also include lateral side walls which provide an element of support for the bracket. While effective for their intended purpose, as will be discussed below such conventional brackets provide numerous disadvantages including potentially at least partially blocking air flow to the motor vehicle engine, and also at least partial blocking of signals emitted by various sensors associated with the motor vehicle fascia. These problems could be addressed by reducing the dimensions (height and length) of the license plate bracket. However, this is not a feasible solution because the dimensions of a license plate, and so the required dimensions of a supporting license plate bracket, are not under the control of the automotive manufacturer. Instead, these dimensions are dictated by various governmental agencies.

To solve these and other problems, the present disclosure relates to a motor vehicle fascia assembly including a floating license plate bracket of relatively simple structure that is advantageously inexpensive to manufacture and provides a reduced depth dimension compared to conventional license plate brackets. Savings in manufacturing cost and component weight, improvements in cooling airflow to the motor vehicle engine, and reduced interference with sensor signals are achieved by use of the described motor vehicle fascia assembly.

### SUMMARY

In accordance with the purposes and benefits described herein, a motor vehicle fascia assembly is provided. The assembly comprises a motor vehicle fascia and a floating license plate bracket.

More specifically, the motor vehicle fascia assembly includes a front fascia panel defining an air inlet structure including upper and lower air inlets disposed at least partially around an intermediate panel, and a license plate mounting bracket secured to the intermediate panel. A substantially central rear rib structure of the license plate mounting bracket contacts the intermediate panel and provides a narrow gap between the license plate mounting bracket rear surface and the intermediate panel. The license plate mounting bracket side edges do not contact the intermediate panel. Air flow is directed around the license plate mounting bracket and into the upper and lower air inlet structures.

The intermediate panel may include a recessed surface for receiving the license plate mounting bracket. The substantially central rear rib structure configuration typically matches a contour or slope of the intermediate panel recessed surface. In embodiments, a top surface of the license plate mounting bracket defines a substantially planar crown radius. In other embodiments, the top surface of the license plate mounting bracket defines an arcuate crown radius whereby at least one side edge of the license plate mounting bracket has a narrower depth dimension than a top or bottom edge of the license plate mounting bracket.

In the following description, there are shown and described embodiments of the disclosed motor vehicle fascia assembly. As it should be realized, the motor vehicle fascia assembly is capable of other, different embodiments and its several details are capable of modification in various, obvious aspects all without departing from the device as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed motor vehicle fascia assembly, and together with the description serve to explain certain principles thereof. In the drawing:

FIG. 1 is a front view of the motor vehicle fascia assembly according to the present disclosure;

FIG. 2 is a rear view of a floating license plate bracket according to the present disclosure;

FIG. 3A illustrates air flow patterns for a motor vehicle fascia assembly including a conventional license plate bracket;

FIG. 3B illustrates improved air flow patterns for a motor vehicle fascia assembly provided by the floating license plate bracket according to the present disclosure;

FIG. 4 is a front perspective view of the motor vehicle fascia assembly according to the present disclosure;

FIG. 5A is a top plan view of the motor vehicle fascia assembly showing a curved embodiment of the floating license plate bracket; and

FIG. 5B is a top plan view of the motor vehicle fascia assembly showing a planar embodiment of the floating license plate bracket.

Reference will now be made in detail to embodiments of the disclosed motor vehicle fascia assembly, examples of which are illustrated in the accompanying drawing figures.

### DETAILED DESCRIPTION

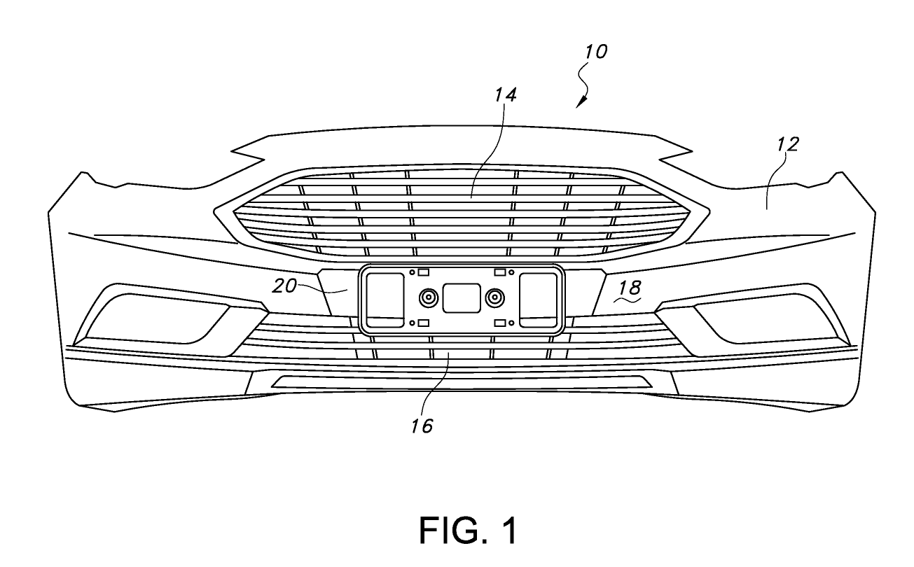

Reference is now made to FIG. 1 illustrating the motor vehicle fascia assembly 10 including in the depicted embodiment a front fascia 12. It will be appreciated that the specific external configuration of the fascia 12 will be dependent on the external configuration of the motor vehicle (not shown) to which the fascia 12 is attached, to provide an aerodynamic and aesthetically pleasing vehicle exterior. The fascia 12 includes an air inlet structure including upper air inlet 14 and lower air inlet 16 for providing cooling air flow to a motor vehicle engine compartment (not shown). The upper air inlet 14 and lower inlet 16 are divided by an intermediate panel 18 which may define or include a recessed surface 20. A floating license plate bracket 22 is secured to the fascia 12 at that recessed surface 20.

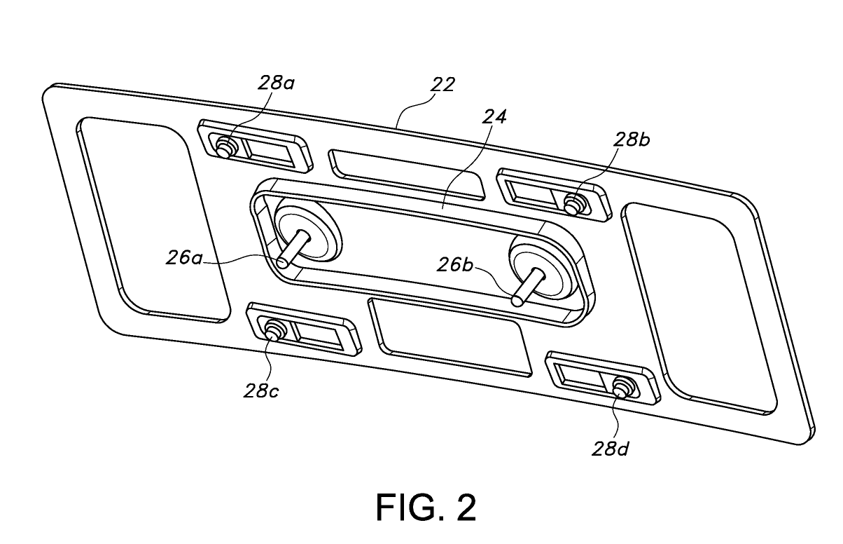

In the depicted embodiment, the floating license plate bracket 22 contacts the fascia 12 at recessed surface 20 via a substantially centrally disposed contact structure rather than requiring contact between the edges of the bracket 22 and a surface of the fascia 12. More specifically, with reference to FIG. 2 the floating license plate bracket 22 includes a rear rib structure 24 disposed substantially centrally on a rear surface of the bracket 22, which rib structure 24 provides the contact between the bracket 22 and the recessed surface 20 of the fascia 12. It will be appreciated that the specific configuration of rib structure 24 may be altered to match the exterior configuration (curvature, slope, etc.) of a specific design of a fascia 12 to which the floating license plate bracket 22 is to be secured. Fasteners 26a, 26b (in a non-limiting example, rivets) are provided for securing the floating license plate bracket 22 to the recessed surface 20 of the fascia 12. Likewise, fasteners 28a, 28b, 28c, and 28d such as substantially conventional nuts are provided on the bracket 22 to allow securing a license plate (not shown) thereto by cooperating bolts (not shown).

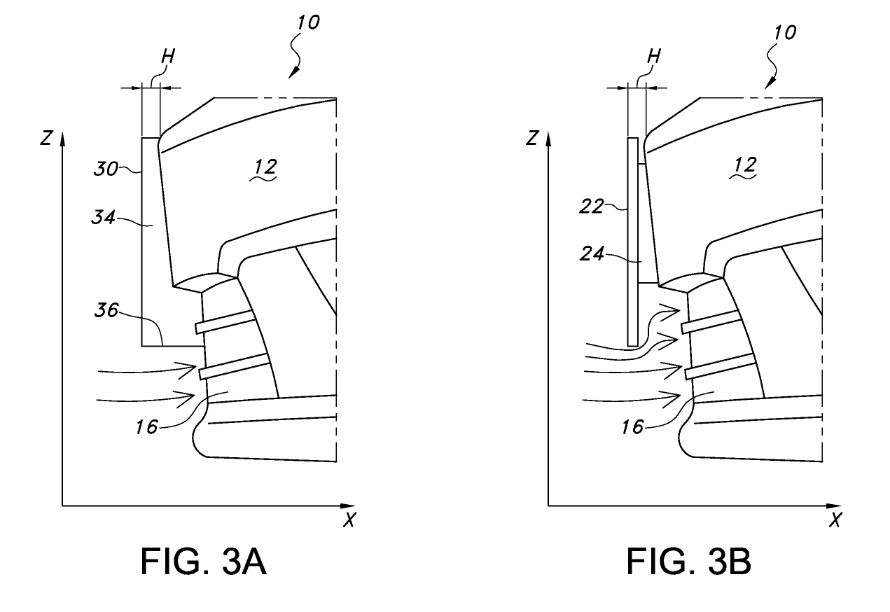

Advantages of the motor vehicle fascia assembly 10 of the present disclosure will now be described. With reference to FIG. 3, a conventional license plate bracket 30 (see FIG. 3a) includes a front surface but also side walls defining a top 32, sides 34, and a bottom 36. Those side walls contact a front surface of the fascia 12. Air flow (see arrows) is allowed through lower inlet 16, but is restricted at least by the sides 34 and bottom 36 of bracket 30.

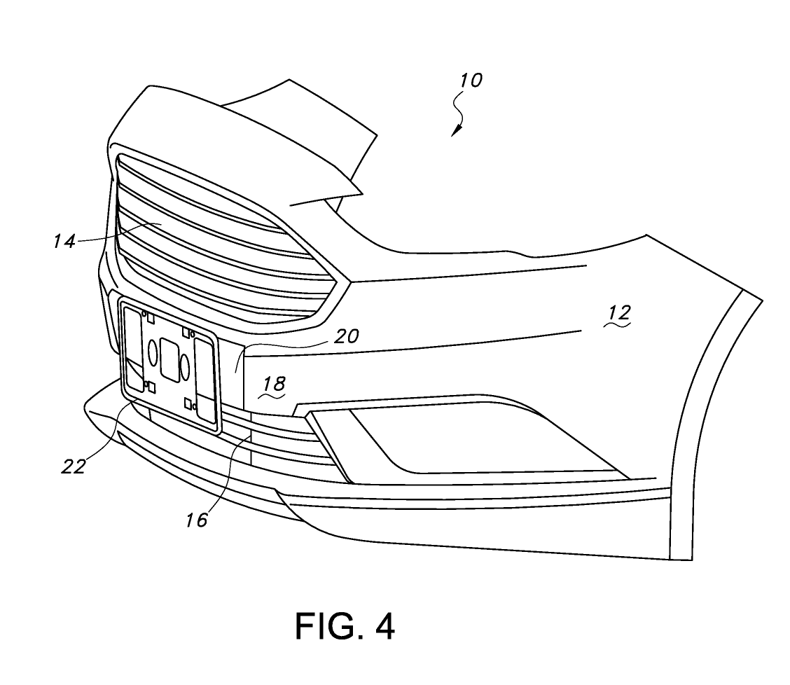

In contrast, with reference to FIG. 3b, only the rib structure 24 of the floating license plate bracket 22 of the present disclosure contacts the fascia 12 (hence the descriptor “floating”). The bracket 22 of the present disclosure, lacking the side walls of the conventional bracket 30 of FIG. 3a, has a reduced height dimension H (from the surface of the fascia 12; see FIGS. 3a and 3b) compared to the conventional bracket 30. Thus, by eliminating the side walls of the conventional bracket 30 (especially bottom 36), the front-facing surface of the floating license plate bracket 22 is positioned closer to the fascia 12 surface (see the vehicle X-axis of FIGS. 3a and 3b). This reduces the overall surface area presented by the bracket 22 without having to reduce the height and length of the bracket 22. In turn, by providing for contact between the floating license plate bracket 22 and the fascia 12 only by way of substantially centrally disposed rear rib structure 24 rather than by the edges of the bracket 22, the bracket 22 can be disposed farther up along an Z-axis of the vehicle compared to the conventional bracket 30 (see FIG. 3b and also FIG. 4).

As shown in FIGS. 3a and 3b, by this altered X-axis positioning and reduced height of the floating license plate bracket 22, cooling air flow through the lower air inlet 16 is increased compared to the airflow provided by a conventional bracket 30, allowing for more efficient operation of the motor vehicle engine (not shown). Moreover, eliminating the side walls of the conventional bracket 30 provides cost savings and reductions in weight of the bracket due to the lesser amounts of material required to fabricate the floating license plate bracket 22. Indeed, the floating license plate bracket 22 of the present disclosure is approximately 46% lighter in weight than a conventional bracket 30 including side walls.

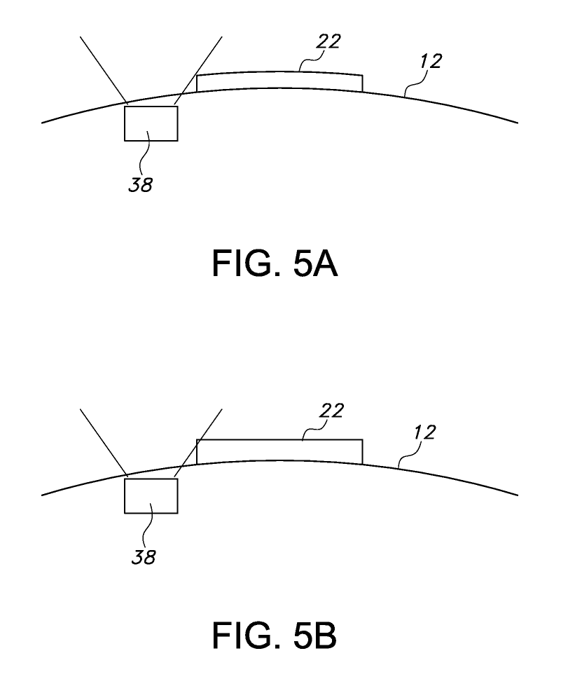

In addition to the foregoing discussion, it is known in modern motor vehicles to provide sensors which emit signals to provide various functionalities to the motor vehicle user. As a non-limiting example, it is known to provide a front-mounted autonomous cruise control (ACC; also called adaptive or radar cruise control) sensor 38 (see FIG. 5). The ACC sensor 38 continuously emits a radar or laser signal when the motor vehicle is in operation, and automatically adjusts the motor vehicle speed to maintain at least a predetermined distance between the motor vehicle and a motor vehicle traveling in front of it.

The lateral or side walls of a conventional license plate bracket 30 such as that depicted in FIG. 3a may partially block such sensor signals because they cause the bracket 30 to extend farther out from a surface of the fascia 12. This could be solved by re-positioning the sensor relative to the bracket 30 (or vice-versa) on or in the vehicle fascia 12 to reduce or prevent such signal interference. However, because of the many components included in a modern motor vehicle, space is often at a premium and even such apparently simple tasks as re-positioning components such as sensors may not be possible without significant and costly re-designs. That is, because of the complexity of the modern motor vehicle, moving a single component such as an ACC sensor may require moving multiple other components, each of which may require moving still other components.

Conveniently, the reduced height of the floating license plate bracket 22 of the present disclosure relative to the fascia 12 surface, in addition to improving cooling airflow patterns as discussed above, also reduces the likelihood of interference with signals emitted by sensors mounted near the license plate bracket such as ACC sensor 38. This is because the reduced height (i.e., the distance the license plate bracket 22 projects from the front surface of the fascia 12) of the floating license plate bracket 22 allows positioning a sensor such as ACC sensor 38 relatively close to the bracket 22 without interfering with the emitted sensor signal.

In summary, numerous benefits are provided by the motor vehicle fascia assembly 10. As should be appreciated, the assembly provides improved airflow patterns, and also reduced interference with signals emitted from sensors positioned in, on, or under the vehicle fascia. Likewise, reductions in weight and component cost are achieved. The foregoing disclosure has been presented for purposes of illustration and description. It is not intended to be exhaustive or to limit the embodiments to the precise form disclosed. Obvious modifications and variations are possible in light of the above teachings. For example, while the floating license plate bracket 22 in the illustrated embodiments is rectangular in shape and substantially flat or planar, in alternative embodiments the bracket 22 may define an arcuate crown radius whereby the side edges of the bracket 22 are narrower than the top and bottom edges, and so disposed even closer to the front surface of the fascia 12 (see FIG. 5a) to further reduce its “footprint” and to further prevent interference with an ACC sensor 38 signal compared even to a substantially planar bracket 22 (see FIG. 5b). Different such shapes and/or contours for the license plate bracket 22 may also be provided in accordance with a shape of the vehicle fascia 12 and/or a particular placement of the ACC sensor 38. All such modifications and variations are within the scope of the appended claims when interpreted in accordance with the breadth to which they are fairly, legally and equitably entitled.

1. A motor vehicle fascia assembly, comprising:
a front fascia panel defining an air inlet structure including upper and lower air inlets disposed at least partially around an intermediate panel; and
a license plate mounting bracket secured to the intermediate panel, wherein the intermediate panel includes a recessed surface for receiving the license plate mounting bracket.

2. The fascia assembly of claim 1, wherein a substantially central rear rib structure of the license plate mounting bracket contacts the intermediate panel.

3. The fascia assembly of claim 2, wherein the substantially central rear rib structure provides a narrow gap between the license plate mounting bracket rear surface and the intermediate panel.

4. The fascia assembly of claim 2, wherein the license plate mounting bracket side edges do not contact the intermediate panel.

5. The fascia assembly of claim 4, wherein air flow is directed around the license plate mounting bracket and into the upper and lower air inlets.

6. (canceled)

7. The fascia assembly of claim 2, wherein the substantially central rear rib structure configuration matches a contour or slope of the intermediate panel recessed surface.

8. The fascia assembly of claim 1, wherein a top surface of the license plate mounting bracket defines a substantially planar crown radius.

9. The fascia assembly of claim 1, wherein a top surface of the license plate mounting bracket defines an arcuate crown radius whereby at least one side edge of the license plate mounting bracket has a narrower depth dimension than a top edge or a bottom edge of the license plate mounting bracket.

10. A fascia assembly for a motor vehicle, comprising:
a front fascia panel including an air inlet structure defining at least upper and lower air inlets disposed at least partially around an intermediate panel; and
a license plate mounting bracket secured to the intermediate panel;
wherein a substantially central rear rib structure of the license plate mounting bracket but not an edge of the license plate mounting bracket contacts the intermediate panel.

11. The fascia assembly of claim 10, wherein the substantially central rear rib structure provides a narrow gap between the license plate mounting bracket rear surface and the intermediate panel.

12. The fascia assembly of claim 11, wherein air flow is directed around the license plate mounting bracket and into the upper and lower air inlets.

13. The fascia assembly of claim 10, wherein the intermediate panel includes a recessed surface for receiving the license plate mounting bracket.

14. The fascia assembly of claim 10, wherein the substantially central rear rib structure configuration matches a contour or slope of the intermediate panel recessed surface.

15. The fascia assembly of claim 10, wherein a top surface of the license plate mounting bracket defines a substantially planar crown radius.

16. The fascia assembly of claim 10, wherein a top surface of the license plate mounting bracket defines an arcuate crown radius whereby at least one side edge of the license plate mounting bracket has a narrower depth dimension than a top edge or a bottom edge of the license plate mounting bracket.

17. A method of improving air flow to a motor of a motor vehicle, comprising:
providing a front fascia panel including an air inlet structure defining at least upper and lower air inlets disposed at least partially around an intermediate panel; and
providing a license plate mounting bracket secured to the intermediate panel;
wherein a substantially central rear rib structure of the license plate mounting bracket but not an edge of the license plate mounting bracket contacts the intermediate panel.

18. The method of claim 17, wherein the substantially central rear rib structure provides a narrow gap between the license plate mounting bracket rear surface and the intermediate panel.

19. The method of claim 18, whereby air flow is directed around the license plate mounting bracket and into the upper and lower air inlets.

20. The method of claim 17, including providing the intermediate panel having a recessed surface for receiving the license plate mounting bracket.
